(19) United States
(12) Patent Application Publication
(10) Pub. No.: US 2005/0222875 A1
(43) Pub. Date: Oct. 6, 2005

(54) System and method for interlinking medical-related data and payment services

(76) Inventors: Frank L. Lordeman, Bentleyville, OH (US); Floyd D. Loop, Gate Mills, OH (US); Peter R. Osenar, Willoughby Hills, OH (US); Jay Zybelman, La Jolla, CA (US)

Correspondence Address: Cameron K. Kerrigan;Squire, Sanders & Dempsey L.L.P., 1 Maritime Plaza, Suite 300, San Francisco, CA, 94111, US

(21) Appl. No.: 10/817,397

(22) Filed: Apr. 2, 2004

(51) Int. Cl. G06F 17/60

(52) U.S. Cl. 705/3

(57) ABSTRACT

The invention enables the aggregation of medical patient financial and medical service access data. With the aggregation of data, a patient can conduct financial and medical-related transactions with different services from a single access point using a single patient identifier and access code. Further, with the aggregation of data, payment to a medical service provider from multiple accounts is automated.

### TECHNICAL FIELD

This invention relates generally to access of medical services and data, and more particularly, but not exclusively, provides a system and method for interlinking medical-related data and services and payment services, such as medical records, health insurance coverage, payment processing, etc. to a wide variety of users.

### BACKGROUND

Conventionally, medical information services and payment services are fragmented. Medical information and records can be stored at a plurality of locations and payment services can be handled by a plurality of different financial institutions. Accordingly, a medical patient will need to carry multiple cards with him and her to gain access to records and payment services. In addition, the medical patient may need to remember multiple locations, account numbers and access codes to access records and payment services. Further, the processing of requests as well as the communication of test results to a patient can take several weeks.

For example, a patient wanting to access all of his or her medical records will need to contact each of the treatment facilities (e.g., doctor's offices, hospitals, clinics, etc.) and give each facility a unique patient identifier and other identifying information. In addition, each treatment facility (or center) may also require a unique access code to release medical records. This is inconvenient for the patient as he or she will have to recall which facilities he or she received treatment at, their contact information, a unique patent identifier for each facility, and possibly a unique access code for each facility.

Further, a patient seeking reimbursement for medical costs must first submit his or her claim to an insurance company, await a decision and receive payment if the decision is positive. If the insurance company payment only covered a portion of the medical costs, the patient must then submit a claim to his or her managed healthcare account(s), if any. If instead, the patient is seeking to pay for medical costs and the managed healthcare account(s) do not have a sufficient balance, then the patient must pay for the medical costs from his or her bank accounts (e.g., checking, credit card, etc.), which requires another transaction. Accordingly, even if a medical service provider submits claims to an insurance company for the patient, the patient may still have two or more transactions to make, which require a significant amount of paperwork in addition to the disadvantages similar to those mentioned above with respect gaining access to medical records. The medical service provider is also disadvantaged as it may not receive payment for an extended period of time.

Further, a patient seeking to understand his bill, how much is outstanding, which organization owes the hospital, etc., cannot now easily access his account details to determine action necessary to pay the account.

Accordingly, a new system and method are needed that overcome the disadvantages mentioned above.

### SUMMARY

Embodiments of the invention enable the aggregation and communication of medical patient financial and medical service access data. With the aggregation of data, a patient (also referred to herein as a cardholder) can conduct financial and medical-related transactions with different services from a single access point using a single patient identifier and access code. Accordingly, the patient need not retain contact information, identifiers and access codes for each service. Further, with the aggregation of data, payment to a medical service provider from multiple accounts is automated.

In an embodiment of the invention, a method comprises: storing medical and financial data that enable access to a plurality of services for a medical patient; accessing one of the plurality of services using a subset of the stored data; and performing a transaction with the accessed service. Transactions can include payments for medical services, purchase of medical products, alert notifications of important medical information (e.g., prescription expirations, test results, appointments, etc.) and other transactions. The medical patient can also store relevant data to enable access only to a subset of the available services that he or she wants to access

In an embodiment of the invention, a system comprises a database and a plurality of service engines communicatively coupled to the database. The database stores medical and financial data that enable access to a plurality of services for a medical patient. The plurality of service engines can each access one of the plurality of services using a subset of the stored data and can perform a transaction with the accessed service.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram illustrating a network system in accordance with an embodiment of the invention;

FIG. 2 is a block diagram illustrating an example computer system capable of hosting nodes of the network system;

FIG. 3A and 3B are diagram illustrating a network system access card;

FIG. 4 is a block diagram illustrating an aggregator system according to an embodiment of the invention;

FIG. 5 is a flowchart illustrating a method of sourcing medical payments;

FIG. 6 is a flowchart illustrating a method of generating revenue for sourcing medical payments;

FIG. 7 is a flowchart illustrating a method of retrieving news relevant to a patient's medical condition; and

FIG. 8 is a flowchart illustrating a method of generating an event notification to a patient.

### DETAILED DESCRIPTION OF THE ILLUSTRATED EMBODIMENTS

The following description is provided to enable any person having ordinary skill in the art to make and use the invention, and is provided in the context of a particular application and its requirements. Various modifications to the embodiments will be readily apparent to those skilled in the art, and the principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

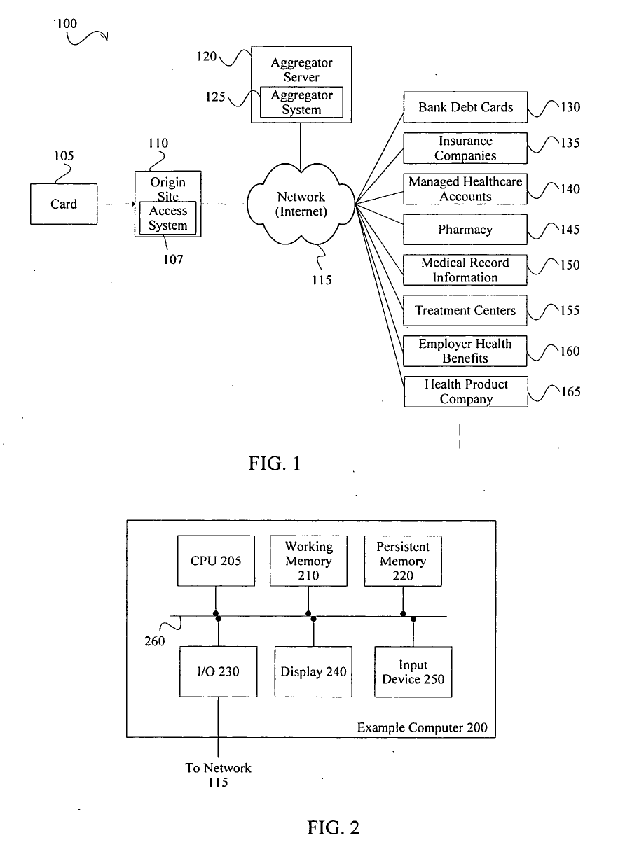

FIG. 1 is a block diagram illustrating a network system 100 in accordance with an embodiment of the invention. The system 100 comprises a network access card 105; an origin site 110 having an access system 107; a network 115 (such as the Internet); an aggregator server 120 comprising an aggregator system 125; and a plurality of services, including payment services: a bank debt card service 130, insurance companies 135, managed healthcare accounts 140, and other services: a pharmacy service 145; a medical record information service 150; a treatment centers service 155; an employer health benefit service 160; and a health product company service 165. It will be appreciated by one of ordinary skill in the art that the network system 100 can include additional or fewer financial and/or medical related services. For example, in an embodiment of the invention, the system 100 can include government medical services.

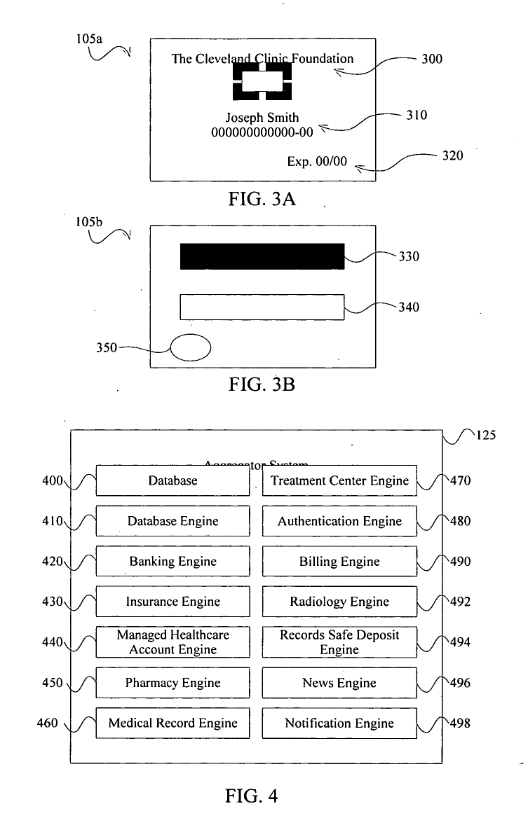

The origin site 110, aggregator server 120, and services 130-165 are each communicatively coupled to each other via the network 115. The origin site 110 reads the card 105 to give access to a cardholder. The card 105, as will be discussed in further detail in conjunction with FIG. 3A and 3B below, enables the cardholder to access any of the services 130-165 via a single card, thereby obviating the need to carry around a plurality of cards for access to services. A further advantage is that as there is only a single card 105 to access a plurality of services, the cardholder need only remember a single access code to access all of the services 130-165. In an embodiment of the invention, the cardholder need not actually have the card 105 in his or her possession to access the plurality of services 130-165 if he or she recalls identifying information from the card 105 and a corresponding access code.

The origin site 110 can include a computer or other device capable of reading the card 105 and communicating with the network 115 and hosts the access system 107, such as a web browser. The origin site 110 can be located at a medical provider, such as a hospital, at a cardholder's home, at a bank, or at any other location. In another embodiment of the invention, the origin site 110 can include a portable computing device (e.g., personal digital assistant, mobile phone, laptop, etc.) and therefore, the origin site 110 can be mobile. The access system 107 enables desktop functions, such as automatically linking to the aggregator system 125, data retention, access code storage, etc. The aggregator server 120 includes an aggregator system 125, which aggregates access to the services 130-165 for each cardholder. The aggregator system 125 will be discussed in further detail in conjunction with FIG. 4.

The services 130-165 include automated data systems of medical and financial vendors and provide medical data and/or financial services to a cardholder that accesses the services 130-165 with the card 105 via the aggregator server 120. More specifically, the bank debt card service 130 can provide payment of medical expenses via a cardholder's bank account(s) (e.g., checking account, credit card, debit card, etc.). The insurance companies 135 can provide insurance data such as coverage, claims filed, claims paid, etc. The insurance companies 135 can also process claims submitted by the cardholder, pay medical service providers and/or reimburse the cardholder via direct deposit in combination with the bank debt card service 130.

The managed healthcare accounts service 140 provides account data (e.g., balance, transactions) for a cardholder's healthcare accounts, such as medical savings accounts, health reimbursement accounts, flexible spending accounts, and. medical spending accounts. The service 140, like the insurance companies service 135, can also process claims submitted by the cardholder, pay medical service providers and/or reimburse the cardholder via direct deposit in combination with the bank debt card service 130 and the aggregator system 125.

The pharmacy service 145, provides cardholders with prescription information, such as medical product (e.g., pharmaceuticals, syringes, wheelchairs, etc.) orders filled, cost of medicine, and information relating to ordered pharmaceuticals (e.g., possible adverse side effects, dosages, etc.). The pharmacy service 145 can also accept medical product orders from a cardholder via the network 115 and request and receive payment from other services via the aggregator system 125.

The medical record information service 150 includes medical records of a cardholder, such as past surgeries, current prescriptions, etc. and can be provided to the cardholder via the aggregator system 125. The treatment center service 155 provides information to a cardholder of upcoming scheduled medical procedures as well as past medical procedures performed at the treatment center. Further, the treatment center service 155 can provide a cardholder appointment schedule (prior and future appointments) to a cardholder. In an embodiment of the invention, the treatment center service 155, in conjunction with the aggregator 125, can also request and receive payment from other services.

The employer health benefit service 160 communicates benefit information, utilization statistics, health messages (e.g., advertisement for diets, etc.) via the aggregator system 125. The health benefit service 160 may also function similarly to the insurance companies service 135 as described above.

The health product company 165, like the pharmacy service 145, enables the ordering of medical-related products, such as vitamins, wheel chairs, crutches, and other non-prescription medical-related products and programs.

During operation of the network system 100, a cardholder gives his or her card 105 to a receptionist that inputs the card 105 into the origin site 110. Alternatively, the cardholder himself or herself may input the card 105 into the origin site 110. The origin site 110 can be located at a hospital or other health service provider. The origin site 110, using the access system 107, reads a cardholder identification number (e.g., social security number or other ID) from a memory of the card 105, as will be discussed in further detail below in conjunction with FIG. 3B. The cardholder then inputs a code or PIN to enable access to the services 130-165 via the aggregator system 125. The origin site, using the access system 107, transmits the ID and code to the aggregator system 125, which then verifies that the cardholder has entered the correct code and therefore has the right to access the services 130-165. In an embodiment of the invention, access may be limited to a subset of the services 130-165, either because services were not activated for a cardholder (e.g., there is no need for access to an insurance company service if the cardholder lacks health insurance) or for some other reason (e.g., a parent may not want a child cardholder to be able to access all services). In an embodiment of the invention, the cardholder can customize the GUI to list only services that he or she is interested in accessing.

Once the correct code is entered, the cardholder or other person (e.g., a receptionist) accessing the network system 100 is then presented with a Graphical User Interface (GUI), via the access system 107, listing all available services. In an embodiment of the invention, the GUI may be branded by, for example, the card 105 issuer. Computer-executable code for the GUI can reside at the origin site 110 or be transmitted from the aggregator system 125 to the origin site 110. The accessor can then select which service to access and provide the appropriate information. For example, a cardholder can specify medical records for a date range. The aggregator system 125 will then access the medical record information service 150, retrieve the relevant data, and transmit it to the origin site 110 for viewing by the cardholder.

In another example, a receptionist requests payment by submitting the charges and medical procedure details to the aggregator system 125. The system 125 then determines the cardholder's insurance based on records in its database 400 (FIG. 4) and contacts the insurance company service 135 for payment. The insurance company makes a partial payment (e.g., pays all charges except for a deductible or co-pay) to the aggregator system 125, which pays the service provider. The aggregator system 125 then next determines if the cardholder has any managed care accounts (e.g., medical savings accounts, health reimbursement accounts, flexible spending accounts, and medical spending accounts) by accessing the database 400 again. If the cardholder does have one, the aggregator system 125 contacts the managed healthcare account service 140 for payment of the balance. The service 140 transmits payment to the aggregator system 125, which then transmits payment to the service provider. If a balance still remains, the aggregator system 125 can access bank information for the cardholder from the database 400 and then contact the bank debt card service 130 for payment and withdraw the balance from the account or charge a credit card. The aggregator system 125 then transmits this payment to the service provider.

In an embodiment of the invention, the aggregator system 125 can also charge a fee for each use/transaction. The fee can be charged to the service provider and/or the cardholder. The fee can be a flat fee per transaction (e.g., $5), a percentage of the transaction revenue (e.g., 2%), or a combination (e.g., $1 per transaction plus 1% of the revenue, if any). In cases where no revenue is generated (e.g., accessing medical record data), only a flat fee will apply. In an embodiment of the invention, the aggregator system 125 can calculate a provider discount for the patient as agreed upon by the service provider for using the aggregator system 125.

Advantages of using the aggregator system 125 for service providers is that it substantially guarantees immediate payment, which will compensate for any transaction fee or discount. Advantages for the cardholder include significantly less paperwork as the cardholder need not seek reimbursement from multiple sources. In addition, the cardholder can also access all of his or her medical information from a single source, thereby obviating the need to keep track of multiple contacts, service provider ID codes and access codes.

In another embodiment of the invention, the aggregator system 125 aggregates health news (e.g., medical journal articles, popular press health articles, etc.) based on a patient's preference and/or based on data retrieved during other transactions. For example, if a patient accesses pharmaceutical records indicating a prescription for insulin, the aggregator system 125 determines that the patient is diabetic and will aggregate health news relating to diabetes. The aggregated news can be stored for display when the patient logs into the system 125 for a transaction and/or can be emailed to the patient.

In another embodiment of the invention, the aggregator system 125 can also email a patient about upcoming appointments and prescription refills.

FIG. 2 is a block diagram illustrating an example computer capable of hosting nodes (e.g., the origin site 110, the aggregator server 120 and the services 130-165) of the network system 100. In an embodiment of the invention, the origin site 110, aggregator system 125, and services 130-165 may include or be resident on a computer that is substantially similar to example computer 200. The example computer 200 includes a central processing unit (CPU) 205; working memory 210; persistent memory 220; an input/output (I/O) interface 230; a display 240 and an input device 250, all communicatively coupled to each other via a system bus 260. The CPU 205 may include an Intel PENTIUM® microprocessor, a Motorola POWERPC® microprocessor, or any other processor capable to execute software stored in the persistent memory 220. The working memory 210 may include random access memory (RAM) or any other type of read/write memory devices or combination of memory devices. The persistent memory 220 may include a hard drive, read only memory (ROM) or any other type of memory device or combination of memory devices that can retain data after example computer 200 is shut off. The I/O interface 230 is communicatively coupled, via wired or wireless techniques, to the network 115. In an alternative embodiment of the invention, I/O 230 may be directly communicatively coupled to a server or computer, thereby eliminating the need for network 140. The display 240 may include a cathode ray tube display or other display device. Input device 250 may include a keyboard, mouse, card reader or other device for inputting data, or a combination of devices for inputting data.

One skilled in the art will recognize that the example computer 200 may also include additional devices, such as network connections, additional memory, additional processors, LANs, input/output lines for transferring information across a hardware channel, the Internet or an intranet, etc. One skilled in the art will also recognize that the programs and data may be received by and stored in the system in alternative ways.

FIG. 3A and 3B are diagram illustrating the network system access card 105. A first (e.g., front) side 105a of the card 105 includes an issuer's (sponsor's) name and logo 300, a cardholder's name and ID number 310 and an expiration date 320. In an embodiment of the invention, the card 105 need not be branded with an issuer's logo. However, as the issuer will bear the cost of issuing the card 105, the issuer will most likely wants its name and logo 300 displayed on the card 105 to promote cardholder loyalty.

A second (e.g., back) side 105b of the card 105 includes a memory device 330, such as a magnetic strip, a signature panel 340 and a Cnexus logo 350. The memory device 330 includes the cardholder's name and ID number 310 from the first side 105a of the card 105 so that when accessing the network system 100 the cardholder need not manually enter this data. In an embodiment of the invention, the memory device 330 can include additional cardholder data, such as contact information and medical information (e.g., allergies, blood type, etc.).

FIG. 4 is a block diagram illustrating the aggregator system 125 according to an embodiment of the invention. The aggregator system 125 translates a cardholder's request into transactions across medical and financial services in a secure (HIPPA compliant) manner. In an embodiment of the invention, the aggregator system 125 is implemented as software engines that reside in a memory of the aggregator server 120. The aggregator system 125 comprises a database 400; a database engine 410; a plurality of payment engines, e.g., a banking engine 420, an insurance engine 430, and a managed healthcare account engine 440; a pharmacy engine 450; a medical record engine 460; a treatment center engine 470; an authentication engine 480; a billing engine 490; a radiology engine 492; a records safe deposit engine 494; a news engine 496; and an notification engine 498.

The database 400 comprises cardholder information, supplied once by the cardholder, including contact information, ID information, password (access code) information, financial information and medical information. Financial information can include bank account numbers and corresponding passwords, credit card numbers, debit card numbers, etc. Medical information can include health insurance information, managed healthcare account numbers and corresponding passwords, a cardholder's service providers (doctors, treatment centers, pharmacies, etc.) and corresponding IDs and passwords, if any, etc. In an embodiment of the invention, the database 400 can further comprise service provider fee schedules that can be used to calculate discounts off services.

The database engine 410 accesses the database 400 for information based on requests from the other engines 420-480 of the aggregator system 125. For example, the authentication engine 480 will query the database engine 410 for a cardholder's access code based on the cardholder's ID. The database engine 410 will retrieve the access code from the database 400 and return it to the authentication engine 480 so that it can authenticate the cardholder trying to gain access to the network system 100.

The banking engine 420 accesses a cardholder's bank accounts (e.g., checking account, credit card, debit card, etc.) to pay service providers for medical services rendered. For example, the banking engine 420, in response to a request from the cardholder or a request from a service provider received by the billing engine 490, will access a cardholder's bank account (as identified in the database 400 in response to a query by the database engine 410) at the bank debt service 130 and transfer cash from the account to the service provider. The banking engine 420 can also charge the cardholder or service provider a fee as discussed above. The banking engine 420 can also access an account at the bank debt card service 130 and transmit banking data (e.g., account balances, recent transactions, etc.) to the cardholder.

The insurance engine 430 submits claims to a cardholder's health insurance at the insurance companies service 135, as identified in the database 400 in response to a query by the database engine 410. The insurance engine 430 can also receive insurance payments from the insurance companies service 135 based on submitted claims and transfer these payments to the service provider or cardholder's account as appropriate. The insurance engine 430 also can check insurance information at the insurance companies service 135, such as satisfied deductible, co-payments, coverage, etc. Like the banking engine 420, the insurance engine 430 can also charge the cardholder and/or service provider a fee for each transaction as discussed above.

The managed healthcare account engine 440 accesses a user's account (e.g., medical savings account, health reimbursement account, flexible spending account, and/or medical spending account, etc.) at the managed healthcare account service 140 based on account information retrieved from the database 400 in response to a database query. The managed healthcare account engine 440 can also retrieve reimbursement/payment from a cardholder's account for a cardholder or service provider, respectively. The managed healthcare account engine 440 can also charge the cardholder and/or service provider a fee for each transaction as discussed above.

The pharmacy engine 450 submits orders to a cardholder's or service provider's preferred pharmacy and then hands off the transaction for payment to the other engines, such as the insurance engine 430, banking engine 420, and/or the managed healthcare account engine 440. The cardholder's preferred pharmacy can be identified in the database 400 in response to a query to the database engine 410. The pharmacy engine 450 also is capable of retrieving pharmaceutical data (e.g., past orders, drug interaction warnings, adverse side effect warnings, dosages, etc.) from the pharmacy and transmitting that data to the origin site 110 for display to the cardholder. The pharmacy engine 450 can also charge the cardholder and/or service provider a fee for each transaction, as discussed above.

The medical record engine 460 accesses medical records via the medical record information service 150, retrieves the records, and transmits them to the origin site 110 for viewing by the cardholder. The location of the medical records as well as the cardholder identification and access code, if any, is stored in the database 400 and retrieved via a query to the database engine 410. The medical record engine 460 can charge the cardholder and/or a service provider for each transaction.

The treatment center engine 470 accesses medical data (e.g., cardholder history, appointment schedules, etc.) at a treatment center via the treatment centers service 155. The cardholder's treatment center is identified in the database 400 and accessed by the database engine 410 in response to a query. The treatment center engine 470 may charge the cardholder and/or treatment center a fee for each transaction.

The authentication engine 480, as mentioned above, receives a cardholder's ID and access code and authenticates the cardholder by comparing the received access code with the access code stored in the database 400. Once the cardholder is authenticated, the cardholder can access services 130-165 via the aggregator system 125. In an embodiment of the invention, the authentication engine 480 can expire the stored access code in the database 400 and require input of a new access code.

The billing engine 490 receives request for payments from service providers (e.g., a pharmacy via the pharmacy service 145 or a treatment center via the treatment center service 155) and arranges payment from a cardholder's insurance, managed healthcare accounts, and/or a cardholder's bank accounts by using the insurance engine 430, managed healthcare account engine 440 and the banking engine 420 respectively.

The radiology engine 492, like the treatment center engine 470, accesses radiological-related data (e.g., patient X-rays, etc.) at a treatment center or other location having radiological-related data. The cardholder's radiological treatment center is identified in the database 400 and accessed by the database engine 410 in response to a query. The radiology engine 470 may charge the cardholder and/or treatment center a fee for each transaction.

In an embodiment of the invention, the aggregator system 125 includes a records safe deposit engine 494, which, in conjunction with the medical record engine 460, stores a patient's medical records in the database 400. Every time the medical record engine 460 retrieves records a medical record information service 150, the records safe deposit engine 494 stores a copy of the retrieved records in the database 400. Further, the records safe deposit engine 494 can cause the medical record engine 460 to access the medical record information service 150 so as to update the database 400 with the patient's most recent records. In an embodiment of the invention, the records safe deposit engine 494 can also transmit stored records to a third party upon a patient's request.

The news engine 496 aggregates health news (e.g., medical journal articles, popular press health articles, etc.) based on a patient's preference and/or based on data retrieved during other transactions. For example, if a patient uses the pharmacy engine 450 to access pharmaceutical records, which indicate a prescription for insulin, the news engine 496 determines that the patient is diabetic and will aggregate health news relating to diabetes. The aggregated news can be stored for display when the patient logs into the system 125 for a transaction and/or can be transmitted to the patient using the notification engine 498.

The notification engine 498, besides transmitting health news, also emails a patient about upcoming appointments, prescription refills, test results, alerts, and other notifcations. The notification engine 498 can regularly access services, such as the pharmacy service 145 and the treatment center service 155 to determine if prescriptions need to be refilled (or other related information, such as expiration of a prescription, a refill is ready, etc.) or if appointments are scheduled by a treatment center by using other engines and patient data in the database 400. If it is determined that prescription or appointment information is relevant, then the notification engine 498 emails the patient with the information. In an embodiment of the invention, the notification engine 498 can transmit the information via other techniques, such as text messaging, voice messaging, etc. In another embodiment of the invention, a cardholder can request an alert when a transaction is complete. For example, a cardholder waiting for a CAT scan report requests the notification engine 498 for the results. The notification engine 498 will then periodically invoke the medical treatment center engine 470 inquire at the cardholder's treatment centers service 155 to obtain the results. Once the results are obtained, the notification engine 498 forwards the results to the cardholder.

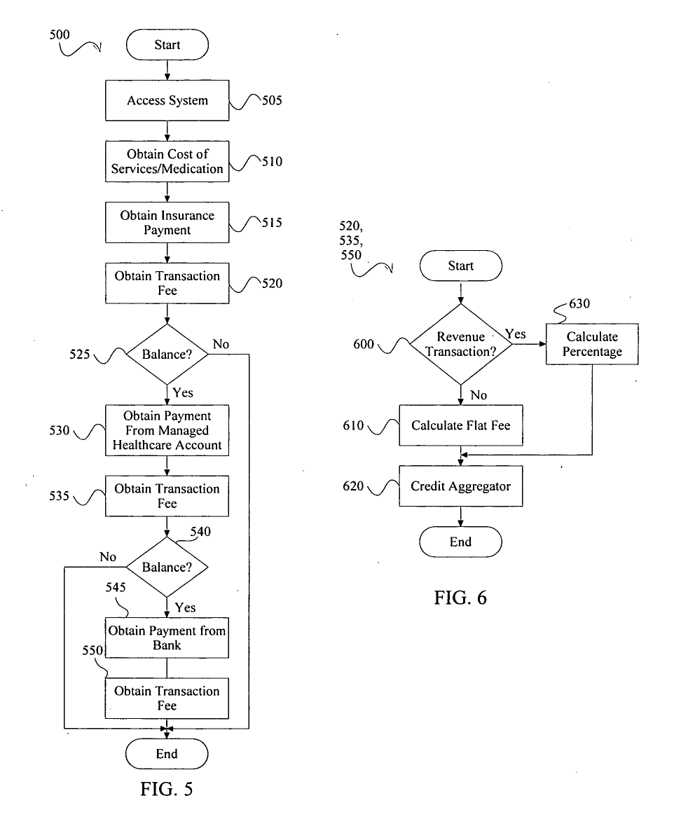

FIG. 5 is a flowchart illustrating a method 500 of sourcing medical payments. In an embodiment of the invention, the aggregator system 125 (e.g., billing engine 490) can execute the method 500 using the services 130-165. First, the system 100 is accessed (505) by authenticating a cardholder. The cost of services or medication is then obtained (510), (e.g., calculated, inputted, or received from a service provider (e.g., a pharmacy via the pharmacy service 450)). In an embodiment of the invention, a discount can also be calculated according to service provider fee schedules stored in the database 400. Payment from a cardholder's insurance is then obtained (515) by identifying the cardholder's insurance in the database 400 and submitting a claim to the insurance via the insurance companies service 135. The obtained payment is then credited to the service provider. A transaction fee can also then be obtained (520), as will be discussed in further detail in conjunction with FIG. 6.

It is next determined (525) if there is a balance left because the insurance payment did not cover the total cost. If there is no balance, then the method 500 ends. If there is a balance, then payment from a cardholder's managed healthcare account is obtained (530) by identifying the account(s) in the database 400 and submitted a request for payment to the account(s) via the managed healthcare accounts service 140. The payment is then credited to the service provider. A transaction fee can then also be obtained (535) as discussed in conjunction with FIG. 6.

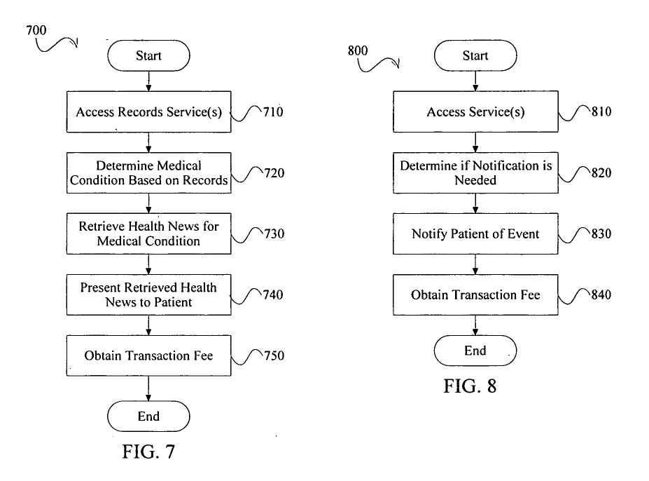

It is next determined (540) if a balance remains after obtaining (530) the managed healthcare account payment. If no balance remains, the method 500 ends. Otherwise, payment is then obtained (545) from a cardholder's bank via the bank debt card service 130 and credited to the service provider. A transaction fee can then be obtained (550) as discussed in conjunction with FIG. 6. The method 500 then ends. As was discussed above and will be discussed in further detail in conjunction with FIG. 7 and FIG. 8 below, other transactions with the accessed services can also be performed.

FIG. 6 is a flowchart illustrating a method (520, 535, or 550) of generating revenue for sourcing medical payments. After each transaction, such as obtaining payment for a service provider, submitting a pharmaceutical order, or retrieving medical records, it is determined (600) if the transaction generated revenue. If no revenue was generated from the transaction, then a flat fee is calculated (610) and credited (620) to the company hosting the aggregator system 125. If revenue was generated from the transaction, a percentage of the transaction is calculated (630) and credited to the aggregator (620). The calculated flat fee or percentage fee can come out of the revenue generated by the transaction or can be in addition to the revenue generated (i.e., if it comes out of the revenue generated, it will reduce the payment made to the service provider/payee; if it is in addition to the revenue generated, the fee will be paid by the payer). The method (520, 535, or 550) then ends. In an embodiment of the invention, the calculation 630 can instead be a flat fee or a combination of a flat fee and a percentage fee.

FIG. 7 is a flowchart illustrating a method 700 of retrieving news relevant to a patient's medical condition. In an embodiment of the invention, the news engine 496 in combination with other elements of the aggregator system 125 can implement the method 700. First, one or more services having records is accessed (710) for a patient using access data stored in the database 400. For example, the pharmacy service 145, medical record information service 150, and/or the treatment center service 155 may be accessed. Based on records in the accessed service(s), it is then determined (720) what medical condition(s) the patient has. For example, records may indicate a diagnosis for high cholesterol based on blood tests or a prescription for insulin may indicate a diagnosis of diabetes. Health news related to the determined conditions is then retrieved (730) from news services, such as YAHOO!™ Health News. The retrieved news is then presented (740) to the user via email, text messaging, or other techniques. A fee can then be obtained (750) and paid to the aggregator as discussed in conjunction with FIG. 6 above. The method 700 then ends.

FIG. 8 is a flowchart illustrating a method 800 of generating an event or alert notification to a patient. In an embodiment of the invention, the notification engine 498, in cooperation with other elements of the aggregator system 125, can execute the method 800. In an embodiment of the invention, the method 800 can be invoked on a regular basis such that the patient receives regular reminders until the required action has been taken. First, using patient access data stored in the database 400, one or more services are accessed (810). For example, the pharmacy service 145 and/or the treatment centers service 150 can be accessed. Based on data stored at the accessed services, it is determined (820) if a notification is needed. For example, it can be determined if an event, such as a doctor's appointment or prescription expiration, is approaching within a predetermined time (e.g., a week). In another embodiment of the invention, it can be determined (820) if new test results are available. The patient is then notified (830), e.g., of the event if it is within the predetermined timeframe so that the patient can take appropriate action (e.g., refill a prescription, travel to a doctor's appointment, etc.) or if new test results are available. A fee can then be obtained (840) and paid to the aggregator as discussed in conjunction with FIG. 6 above. The method 800 then ends.

The foregoing description of the illustrated embodiments of the present invention is by way of example only, and other variations and modifications of the above-described embodiments and methods are possible in light of the foregoing teaching. Although the network sites are being described as separate and distinct sites, one skilled in the art will recognize that these sites may be a part of an integral site, may each include portions of multiple sites, or may include combinations of single and multiple sites. Further, components of this invention may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

1. A computer-based method, comprising:
storing medical and financial data that enable access to a plurality of services for a medical patient;
accessing one of the plurality of services using a subset of the stored data; and
performing a transaction with the accessed service.

2. The method of claim 1, further comprising charging a fee for the performing.

3. The method of claim 2, wherein the fee includes a flat fee.

4. The method of claim 2, wherein the fee includes a percentage of revenue in the transaction.

5. The method of claim 1, further comprising verifying an identity of the patient by comparing a patient identifier on a patient's card and an access code with data stored in a database.

6. The method of claim 1, wherein financial data includes a bank account identifier.

7. The method of claim 1, wherein the medical data includes patient insurance data.

8. The method of claim 1, wherein the medical data includes a managed healthcare account identifier.

9. The method of claim 1, further comprising repeating the accessing and performing until a health service provider's claim is fully paid.

10. The method of claim 9, wherein the accessed services include a health insurance service, a managed healthcare account service, and a bank debt service.

11. The method of claim 9, further comprising calculating a health service provider discount.

12. The method of claim 1, wherein the transaction includes obtaining patient appointment data and wherein the method further comprises transmitting the obtained patient appointment data.

13. The method of claim 1, wherein the transaction includes obtaining pharmaceutical information and wherein the method further comprises
determining a medical condition based on the pharmaceutical information; and
obtaining news related to the determined medical condition.

14. The method of claim 1, wherein the transaction includes obtaining pharmaceutical information and wherein the method further comprises
determining if a prescription is going to expire within a predetermined timeframe; and
transmitting a notification of the expiration to a patient if the expiration is within the predetermined timeframe.

15. A system, comprising:
means for storing medical and financial data that enable access to a plurality of services for a medical patient;
means for accessing one of the plurality of services using a subset of the stored data; and
means for performing a transaction with the accessed service.

16. A computer-readable medium having stored thereon instructions to cause a computer to execute a method, the method comprising:
storing medical and financial data that enable access to a plurality of services for a medical patient;
accessing one of the plurality of services using a subset of the stored data; and
performing a transaction with the accessed service.

17. A system, comprising:
a database capable of storing medical and financial data that enable access to a plurality of services for a medical patient; and
a plurality of service engines, each communicatively coupled to the database, each capable of accessing one of the plurality of services using a subset of the stored data and capable of performing a transaction with the accessed service.

18. The system of claim 17, wherein the plurality of service engines each charge a fee for performing a transaction.

19. The system of claim 18, wherein the fee includes a flat fee.

20. The system of claim 18, wherein the fee includes a percentage of revenue in the transaction.

21. The system of claim 17, further comprising an authentication engine, communicatively coupled to the database, capable of verifying an identity of the patient by comparing a patient identifier on a patient's card and an access code with data stored in the database.

22. The system of claim 17, wherein financial data includes a bank account identifier.

23. The system of claim 17, wherein the medical data includes patient insurance data.

24. The system of claim 17, wherein the medical data includes a managed healthcare account identifier.

25. The system of claim 17, further comprising a billing engine that invokes different engines of the plurality of engines until a health service provider's claim is fully paid.

26. The system of claim 25, wherein the accessed services include a health insurance service, a managed healthcare account service, and a bank debt service.

27. The system of claim 25, wherein the billing engine is further capable of calculating a health service provider discount.

28. The system of claim 17, wherein the transaction includes obtaining patient appointment data and wherein the system further comprises an notification engine capable of transmitting the obtained patient appointment data.

29. The system of claim 17, wherein the transaction includes obtaining pharmaceutical information and wherein the system further comprises a news engine capable of determining a medical condition based on the pharmaceutical information and capable of obtaining news related to the determined medical condition.

30. The system of claim 17, wherein the transaction includes obtaining pharmaceutical information and wherein the system further comprises an notification engine capable of determining if a prescription is going to expire within a predetermined timeframe; and capable of transmitting a notification of the expiration to a patient if the expiration is within the predetermined timeframe.
